(19) United States
(12) Patent Application Publication
(10) Pub. No.: US 2007/0021252 A1
(43) Pub. Date: Jan. 25, 2007

(54) Tensioning system

(75) Inventor: Hans-Rudolf Jenni, Grasswill (CH)

Correspondence Address: Michael M. Zadrozny;SHLESINGER, ARKWRIGHT & GARVEY LLP, Suite 600, 1420 King Street, Alexandria, VA, 22314, US

(73) Assignee: Weber Motor AG

(21) Appl. No.: 11/489,617

(22) Filed: Jul. 20, 2006

(30) Foreign Application Priority Data
Jul. 21, 2005 (DE) 10 2005 035 076.3

(51) Int. Cl. F16H 7/08; F16H 7/18

(52) U.S. Cl. 474/111; 474/140

(57) ABSTRACT

The invention relates to a tensioning system (12) for a driving member (8) which cooperates with a motor. This tensioning system (12) comprises a sliding rail (16) for loading the driving member (8), a tensioning element (14) and a lever (18). The lever (18) is constructed in this case to transmit a force from the tensioning element (14) to the sliding rail (16).

The invention relates to a tensioning system for a driving member, which cooperates with a motor, and to a motor.

A tensioning system which can be constructed as a chain adjuster for example, takes on a range of functions within a timing assembly which cooperates with a motor. Using the tensioning system a chain, which cooperates with the motor, is pretensioned in different operating conditions under a defined load such that elongations arising in the timing chain due to wear, which occur during operation of the timing chain, can be compensated. A damping element in the tensioning system also reduces vibrations in the timing chain to an admissible size.

In a conventional motor a tensioning element of a tensioning system presses directly on a chain sliding rail which is provided for loading the timing chain. A tensioning element of this type must also have a precisely defined position within the timing assembly.

Taking this as a starting point, a tensioning system with the features of claim 1 and a motor with the features of claim 12 are introduced.

According to the invention, the tensioning system for a driving member which cooperates with a motor comprises a sliding rail for loading the driving member, a tensioning element and a lever. In this case the lever is constructed to transmit a force from the tensioning element to the sliding rail.

This configuration of the tensioning system makes it possible to adequately tension the driving member in any operating situation. The lever also means that extended spatial positioning of the tensioning element is possible. The tensioning system can be arranged in such a way that the sliding rail tensions the driving member both on a loose side of a belt and on a taut side of a belt.

In the tensioning system the lever preferably transmits the force or tensioning force from the tensioning element to the sliding rail in such a way that, at least in certain sections, there is a substantially linear correlation between an elongation distance of the sliding rail and a force of the tensioning element. The elongation distance is in this case the distance by which the sliding rail of the tensioning system displaces the driving member from a track. A linear characteristic of this type between the elongation distance and the tensioning force is preferably given at least in intervals relevant to the operation of the driving member within the motor for the elongation distance and the tensioning force.

As a result of the tensioning system, elongations due to wear and driving member vibrations that occur during operation of the driving member can be reduced by a damping effect of the tensioning system.

In one embodiment of the present tensioning system it is provided that the lever is rotatable relative to the sliding rail. A fulcrum of the lever can in the process be integrated in the sliding rail. In addition, the sliding rail can comprise a receiving device for receiving the lever. The receiving device can be constructed in such a way that a rotational movement and/or possibly a minimal relative movement of the lever with respect to the sliding rail is/are possible.

The fulcrum and the receiving device of the lever can be arranged in the sliding rail. As the lever produces an interaction between the tensioning element and the sliding rail, the lever is arranged as it were between the sliding rail and the tensioning element even if the lever is connected to the sliding rail and/or integrated therein at least in certain regions.

The force produced by the tensioning element is accordingly transferred by the lever and optionally intensified. With an elongation distance or displacement distance of the sliding rail resulting from a given force it is thus possible to load the driving member with an intensified force. Using the lever within the tensioning system the driving member is tensioned by a constant force and, in addition, the lever can be used as an intensifier for the force produced by the tensioning element.

The tensioning system lever typically consists of a body and comprises two arms, with one of the two arms in each case extending from the fulcrum of the lever. The two arms may each comprise main axes, wherein the main axes of the two arms can be arranged at a suitable angle to each other. In a preferred embodiment the axes of the two arms are arranged parallel to each other and align with each other, so the two arms are separated from each other at the fulcrum.

The first of the two arms has a first length or lever length and the second of the two arms has a second length or lever length. The two arms can have identical or different lengths, depending on the specific use of the lever within the tensioning system and as a function of the track along which the driving member runs.

Transmission of the tensioning force from the tensioning element to the sliding rail by means of the lever may also be promoted by the shape of the lever. Thus, the lever may, for example, have a curved or rounded surface along which the lever moves or rolls relative to the sliding rail during a rotation.

It is provided that the tensioning element is constructed to cooperate with the first arm of the lever. In a preferred configuration the tensioning element is constructed to load the first arm of the lever. The second arm of the lever cooperates with the motor and in particular a crankcase of the motor. This can mean that the second arm of the lever is supported on the motor and preferably on the crankcase of the motor. With appropriate shaping of the arms, in particular if they are delimited by curved or rounded surfaces, the arms may roll on the tensioning element and the crankcase.

The tensioning system lever can also be constructed in such a way that the force produced by the tensioning element is compensated according to the lever principle by the lever being supported on the crankcase of the motor. The rotational movement of the lever that results in the process is transmitted to the sliding rail, so the driving member is uniformly tensioned. If the driving member should be exposed to particular variations during operation, forces that result in the process are in turn absorbed by the tensioning system.

Such a mode of operation of the tensioning element can be adjusted by suitably selecting the lengths of the two arms. The choice of these lengths, for example with respect to a proportion of the lengths of the arms to each other, should be made inter alia as a function of a configuration and/or arrangement of the tensioning element and the sliding rail. It should also be taken into account how the individual components of the tensioning system, in other words the sliding rail, the fulcrum of the lever in the sliding rail, the tensioning element and the location at which the lever is supported on the motor and in particular the crankcase of the motor, are spatially arranged with respect to each other.

With the lever a linear characteristic can thus be achieved between the elongation distance of the sliding rail and the tensioning force of the tensioning element. The tensioning element is constructed to provide a tensioning force that acts in a damping manner. For this purpose, the tensioning element may comprise a damping element which damps the tensioning element either by frictional damping or by viscous damping. The tensioning element is constructed as a hydraulic chain adjuster or belt tightener for example, depending on the construction of the driving member.

The tensioning system is provided for a timing assembly. This timing assembly comprises the driving member which contacts a number of wheels of the motor. These wheels are fastened to shafts of the motor. The driving member is preferably constructed as an inherently endless member and transmits rotational movements between the wheels of the motor. The tensioning system is configured to provide tensioning of a driving member constructed as a chain. It is also possible, however, to tension a driving member constructed as a belt using the tensioning system.

The motor according to the invention comprises a number of shafts, a driving member which cooperates with at least two of the shafts, and at least one tensioning system according to the invention, as described above.

As the motor according to the invention comprises the tensioning system according to the invention, rotational movements can be effectively transmitted between individual shafts of the motor via the driving member. The driving member of this motor is optimally tensioned in all motor operating states, so the motor has optimum efficiency.

It is conventionally provided that the at least two shafts comprise a respective wheel and that the driving member winds around the wheels of the at least two shafts.

Further advantages and configurations of the invention can be found in the description and the accompanying drawing.

It is understood that in addition to the respective given combination, the abovementioned features as well as the features yet to be described may be used in other combinations or alone without departing from the scope of the present invention.

The invention is schematically illustrated in the drawing using an embodiment and will be described in detail hereinafter with reference to the drawing, in which:

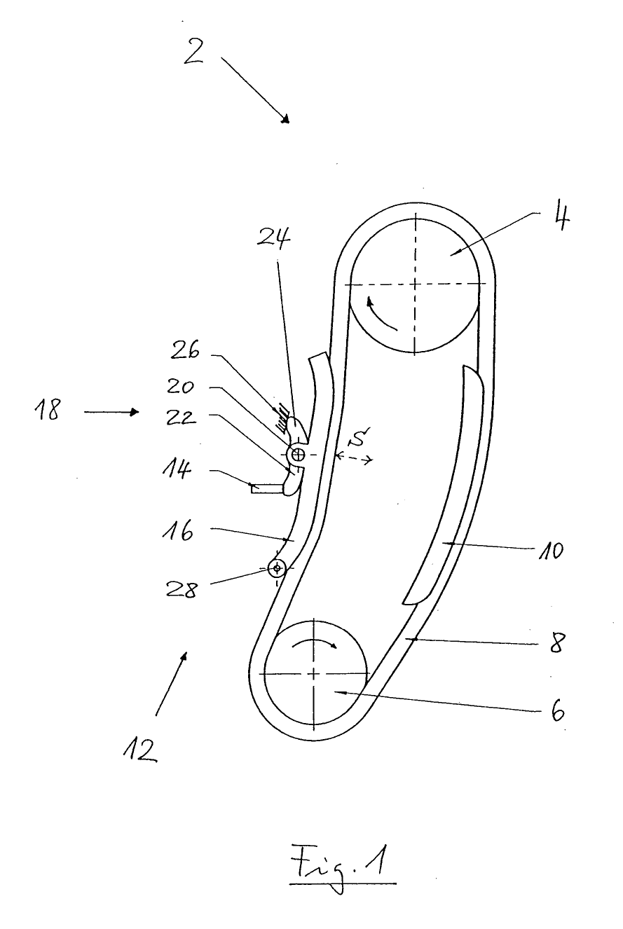

FIG. 1 shows in a schematic diagram, a preferred embodiment of a timing assembly with a tensioning system.

The timing assembly 2 shown in FIG. 1 comprises a first wheel 4 and a second wheel 6. These two wheels 4, 6 are fastened to the ends of shafts of a motor (not shown here). The two wheels 4, 6 are contacted by an endless driving member 8 which is constructed in this case as an endless chain.

It is also provided in this embodiment that the first wheel 4 is driven by the corresponding shaft of the motor and in the process executes a rotational movement in the clockwise direction. The driving member 8 is set in motion by the first wheel 4 and transmits this rotational movement to the second wheel 6, so this second wheel 6 also executes a rotational movement in the clockwise direction. The directions of the rotational movements are illustrated by the curved arrows.

The present timing assembly 2 comprises a guide rail 10 along which the driving member 8 slides during operation of the motor. The timing assembly 2 also comprises a tensioning system 12 that consists of a plurality of components and is constructed to tension the driving member 8 in any operating situation of the motor such that rotational movements are effectively transmitted between the wheels 4, 6.

This tensioning system 12 comprises a hydraulically operated tensioning element 14, a sliding rail 16 and a lever 18. A fulcrum 20 of the lever 18 is received in a receiving device of the sliding rail 16, so the lever 18 can rotate about the fulcrum 20 relative to the sliding rail 16.

The lever 18 comprises a first arm 22 and a second arm 24. These two arms 22, 24 extend from the fulcrum 20 of the lever 18. In the present embodiment the lever 8 has a banana-shaped profile which is asymmetrically constructed with respect to a line extending through the fulcrum perpendicular to the two arms 22, 24.

If, in addition to the rotation, the lever 18 can execute a limited relative movement with respect to the sliding rail 16, a portion of the profile of the lever 18 that faces the sliding rail 16 can roll on the back of the sliding rail 16.

The second arm 24 of the lever 18 cooperates with a crankcase 26 (shown only in certain sections here) of the motor. In this case, one end of this second lever 24 is articulated to the crankcase 26, so the lever 18 is supported on the crankcase 26 via the second arm 24. The first arm 22 of the lever 18 cooperates with the tensioning element 14. For this purpose, one end of the first arm 22 of the lever 18 is articulated to the tensioning element 14 or is hinged to this tensioning element 14, so the tensioning element 14 loads the lever 18 via the first arm 22, bringing about a change in the position of the end of this first arm 22.

The, as a whole, two-armed or two-sided lever 18 compensates a first torque which results from a product of a length of the first arm 22 and the force produced by the tensioning element 14 and acting on the first arm 22, and a second torque which results from a product of a length of the second arm 24 and a force resulting on the second arm 24 owing to support on the crankcase 26.

During operation of the motor a, for example, temperature-dependent force or tensioning force is produced by the tensioning element 14. As a result, the end of the first arm 22 of the lever 18 is reciprocated owing to a load produced by this force. As the end of the second arm 24 of the lever 18 is supported on the crankcase 26, overall a movement of the lever 18 is thus produced, wherein the lever 18 rotates about the fulcrum 20 relative to the sliding rail 16.

The sliding rail 16 is received so as to be rotatably mounted at one end in a rotary locating point 28 and is constructed so as to be substantially U-shaped in profile, so the driving member 8 is at least partially received inside the sliding rail 16 and slides along a sliding surface of the sliding rail 16 that is hidden in FIG. 1.

The force or tensioning force produced by the tensioning element 14 is transmitted by the lever 18 to the sliding rail 16 such that the rail executes a relative movement by an elongation distance S which is shown here by the broken-line double arrow. A track of the driving member 8 along the sliding rail 16 is locally varied as a result and the driving member 8 is thus tensioned in any motor operating situation. As a result of the illustrated configuration of the lever 18 there is a linear correlation between the tensioning force of the tensioning element 14 and the elongation distance S of the sliding rail 16 on transmission of the tensioning force by the lever 18. A constant force or tensioning force is transmitted to the driving member 8 in all operating situations by the lever 18 acting as an intermediate element between the tensioning element 14 and the sliding rail 16.

In the present embodiment the first wheel 4 is connected to a camshaft of the motor and the second wheel 6 to a crankcase of the motor. Increasing longitudinal forces, which act on the driving member 8, are produced owing to increasing camshaft torques, rotational uniformity of the crankcase and a polygon effect. Consequently there is dynamic loading of the driving member 8 which can, however, be effectively absorbed by the tensioning system 12 in question.

1. Tensioning system for a driving member (8), which cooperates with a motor, which comprises a sliding rail (16) for loading the driving member (8), a tensioning element (14) and a lever (18), the lever (18) being constructed to transmit a force from the tensioning element (14) to the sliding rail (16).

2. Tensioning system according to claim 1, wherein the lever (18) transmits the force such that there is a linear correlation between and elongation distance of the sliding rail (16) and the force of the tensioning element (14).

3. Tensioning system according to claim 1, wherein the lever (18) is rotatable relative to the sliding rail (16).

4. Tensioning system according to claim 1, wherein a fulcrum (20) of the lever (18) in integrated in the sliding rail (16).

5. Tensioning system according to claim 4, wherein the sliding rail (16) comprises a receiving device for receiving the fulcrum (20) of the lever (18).

6. Tensioning system according to claim 6, wherein the tensioning element (14) is constructed to cooperate with a first arm (22) of the lever (18).

7. Tensioning system according to claim 6, wherein the tensioning element (14) is constructed to load the first arm (22) of the lever (18).

8. Tensioning system according to claim 7, wherein a second arm (24) of the lever (18) cooperates with a crankcase (26) of the motor.

9. Tensioning system according to claim 8, wherein the second arm of the lever (18) is supported on the crankcase (26) of the motor.

10. Tensioning system according to claim 9, for a timing assembly (2), wherein the driving member (8) winds around a number of wheels (4, 6) of the motor.

11. Tensioning system according to claim 10, which is provided for tensioning a driving member (8) constructed as a chain.

12. Motor, which comprises a number of shafts, a driving member (8), which cooperates with at least two of the shafts, and at least one tensioning system (12) which comprises a sliding rail for loading the driving member, a tensioning element and a lever, the lever being constructed to transmit a force from the tensioning element to the sliding rail.

13. Motor according to claim 12, wherein one of the at least two shafts in each case comprises a wheel (4, 6) and the driving member (8) winds around the wheels (4, 6) of the at least two shafts.
